(19) United States
(12) Patent Application Publication
(10) Pub. No.: US 2026/0278542 A1
(43) Pub. Date: Sep. 17, 2026

(54) Systems, Media, and Methods for Identifying and Correcting Retailer Phantom Inventory

(71) Applicant: 3M INNOVATIVE PROPERTIES COMPANY, St. Paul, MN (US)

(72) Inventors: Brendan P. Miller, Maplewood, MN (US); Frederick J. Arsenault, Stillwater, MN (US); Jonathan T. Kahl, Woodbury, MN (US); Sean T. Kalafut, Minneapolis, MN (US); Peter G. Klink, St. Paul, MN (US); Wilmina M. Marget, Rosemount, MN (US); Peter O.N. Olson, Columbus, OH (US); Tyler W. Olson, Esko, MN (US); Angela L. Reda, St. Paul, MN (US); Brian E. Brooks, St. Paul, MN (US); Audrey M. Salerno, Chicago, IL (US); Ardavan Sassani, Atlanta, GA (US)

(21) Appl. No.: 19/163,119

(22) PCT Filed: Apr. 2, 2024
(86) PCT No.: PCT/IB2024/053192

§ 371 Date: Sep. 8, 2025

Related U.S. Application Data
(60) Provisional application No. 63/456,580, filed on Apr. 3, 2023.

(51) Int. Cl. G06Q 10/087; G06N 7/01; G06Q 10/0639

(52) U.S. Cl. CPC G06Q 10/08772; G06N 7/01; G06Q 10/06393; G06Q 10/08726

(57) ABSTRACT

A method includes calculating model probabilities and a ranked list of locations and receiving a selection of a plurality of the ranked locations. The method also includes receiving actual item count data from at least a subset of the selected locations and comparing the actual item count data to a corresponding inventory record. The method further includes outputting a discrepancy indication based upon a discrepancy between the actual item count data and the corresponding inventory record.

### BACKGROUND

Phantom inventory is a common source of lingering empty shelves, lost sales for retailers, and frustration for their customers. Phantom inventory occurs when a retailer's inventory system reports an item has inventory on hand at a store, but that item is not actually currently available within the store for a consumer to purchase. There are various potential root causes for phantom inventory, for example the store receiving less inventory than allocated, a returned item being logged into inventory but later discarded as damaged, a consumer moving an item to elsewhere such that it is effectively lost, and theft.

### SUMMARY

In an embodiment, a method includes calculating model probabilities and a ranked list of locations and receiving a selection of a plurality of the ranked locations. The method also includes receiving actual item count data from at least a subset of the selected locations and comparing the actual item count data to a corresponding inventory record. The method further includes outputting a discrepancy indication based upon a discrepancy between the actual item count data and the corresponding inventory record.

In another embodiment, at least one non-transitory computer-readable medium encoded with instructions that, when executed, configure at least one processor for calculating model probabilities and a ranked list of locations and receiving a selection of a plurality of the ranked locations. The non-transitory computer-readable medium also includes instructions for receiving actual item count data from at least a subset of the selected locations and comparing the actual item count data to a corresponding inventory record. The non-transitory computer-readable medium further includes instructions for outputting a discrepancy indication based upon a discrepancy between the actual item count data and the corresponding inventory record.

In yet another embodiment, a system includes at least one computing device comprising one or more processors and at least one memory coupled to at least one of the one or more processors. The at least one memory includes instructions that configure the at least one computing device to calculate model probabilities and a ranked list of locations and receive a selection of a plurality of the ranked locations. The at least one computing device is further configured to receive actual item count data from at least a subset of the selected locations and compare the actual item count data to a corresponding inventory record. The at least one computing device is also configured to output a discrepancy indication based upon a discrepancy between the actual item count data and the corresponding inventory record.

### BRIEF DESCRIPTION OF THE DRAWINGS

FIG. 1 is a diagram illustrating a phantom inventory identification and correction operations according to various embodiments herein;

FIG. 2 is a diagram illustrating data splits used for classification model training, tuning, and testing according to various embodiments herein;

FIG. 3 is a measure of feature importance for a Light Gradient Boosting Machine model according to various embodiments herein;

FIG. 4A is a graph that illustrates feature dependance for the number of days since the last sale according to various embodiments herein;

FIG. 4B is a graph that illustrates feature dependance for the number of inventory units according to various embodiments herein;

FIG. 5A illustrates an example of in-store audit to count products on the shelf and correct any cases of phantom inventory in the store system according to various embodiments herein;

FIG. 5B is a diagram illustrating a hierarchy of product flow according to various embodiments herein;

FIG. 6A illustrates an example of an actual weighted value payoff matrix according to various embodiments herein;

FIG. 6B illustrates an example of an actual unweighted value payoff matrix according to various embodiments herein;

FIG. 6C illustrates an example of a randomized weighted value payoff matrix according to various embodiments herein;

FIG. 6D illustrates an example of a randomized unweighted value payoff matrix according to various embodiments herein;

FIG. 7 illustrates a payoff matrix according to various embodiments herein;

FIG. 8 illustrates a flowchart for identifying/correcting phantom inventory according to various embodiments herein;

FIG. 9 illustrates a front-end user interface of a software application according to various embodiments herein; and

FIG. 10 is a block diagram that illustrates computing hardware used according to various embodiments herein.

### DETAILED DESCRIPTION

Phantom inventory can include impacts in which a consumer may be inconveniently deprived of the opportunity to purchase an item. In some cases, the consumer may substitute to another item which may have a different profit margin, sale price, or other business attributes. In other cases, the consumer may simply leave the store such that the retailer may lose all potential sales from what the customer would have otherwise purchased. Worse, the consumer may elect to stop shopping with that retailer entirely and switch to a competitor.

A product manufacturer may also have a vested interest in preventing phantom inventory. Both the manufacturer and the retailer may benefit when the consumer purchases the item. In embodiments, retailers generally re-order products based on automated algorithms that trigger when reported inventory dips below a threshold, they may also take fluctuating or seasonal demand into account. If there is no automated algorithm to provide a fallback cadence for re-ordering, an instance of phantom inventory may prevent an automatic inventory re-order for an extended period.

The challenge for a retailer can be that manual audits to correct phantom inventory are time-consuming and expensive, both in terms of hourly wage time and the lost opportunity of better utilization of a worker, who could be performing other revenue-generating duties. It may also be inefficient to do ongoing manual audits, as not all items are equally likely to be in a state of phantom inventory, nor are all items equally valuable to correct from a state of phantom inventory in view of finite resources and time. Identifying and correcting phantom inventory therefore benefits the manufacturer, the retailer, and the consumer.

Methods, media, and systems for identifying and correcting phantom inventory are described herein. In an identification operation, a classification model may identify the items and classifies item categories at a given store on a given day that are likely to be in a state of phantom inventory in the future (hours, days, weeks, and the like). In a correction operation, the classification model may prioritize, based on an estimated net value and results of the identification operation, those items, item categories, and stores that require an intervention. The intervention may comprise correcting a retailer inventory system or reordering. The algorithmic process for the identification operation and the correction operation are flexible, and illustrative implementation examples are provided herein.

In embodiments, the identification operation may be accomplished using a classification model. The classification model inputs may include point-of-sale (POS) trends, such as how many days it has been since the item last sold at that store and/or item characteristics, such as the physical size. Classification model inputs may also include planogram (POG) characteristics, such as the height of the shelf on which the item is located and/or store characteristics, such as overall sales volume, that are used to compare item sales at this store to similar stores. The classification model may output phantom inventory probability scores between 0 and 1 (or may utilize any other suitable range), where by way of non-limiting example, probabilities closer to 1 indicate a higher likelihood of the item being in a phantom inventory state, such as the next day in this non-limiting example. Class labels may be used to indicate whether or not a given item is predicted to be in a phantom inventory state (in this example, these are binary, such that yes=1, no=0) and may be calculated based on a chosen probability threshold that can be either static or dynamic. The adjustable probability threshold can be adjusted at a category or item level, for example. By way of non-limiting example, increasing the threshold would reduce the number of positive predictions but increase the precision of those predictions, whereas lowering the threshold would increase the number of positive predictions (increasing the sensitivity or recall) but decrease the precision. In some embodiments, the adjustable probability threshold allows flexibility for business constraints or preferences around costs and benefits of correcting predicted cases of phantom inventory. In some embodiments, the ranked locations are determined at least in part by a payoff matrix estimate calculation. In various embodiments, the at least one processor is further configured for outputting instructions to replenish inventory for unavailable items or as indicated by a model as being likely unavailable. In some embodiments, the ranking of locations is based at least in part on an overall value of fixing the discrepancy within a category. In various embodiments, the at least one processor is further configured for monitoring the classification model performance with calculated performance metrics based at least in part on received input comprising auditor intervention to correct inventory quantity, wherein the monitoring further comprises utilizing performance metrics for model degradation, and wherein the at least one processor is further configured for retraining the model based upon detected model degradation. In some embodiments, the model probability comprises a probability of an item not being present at a location on a particular date.

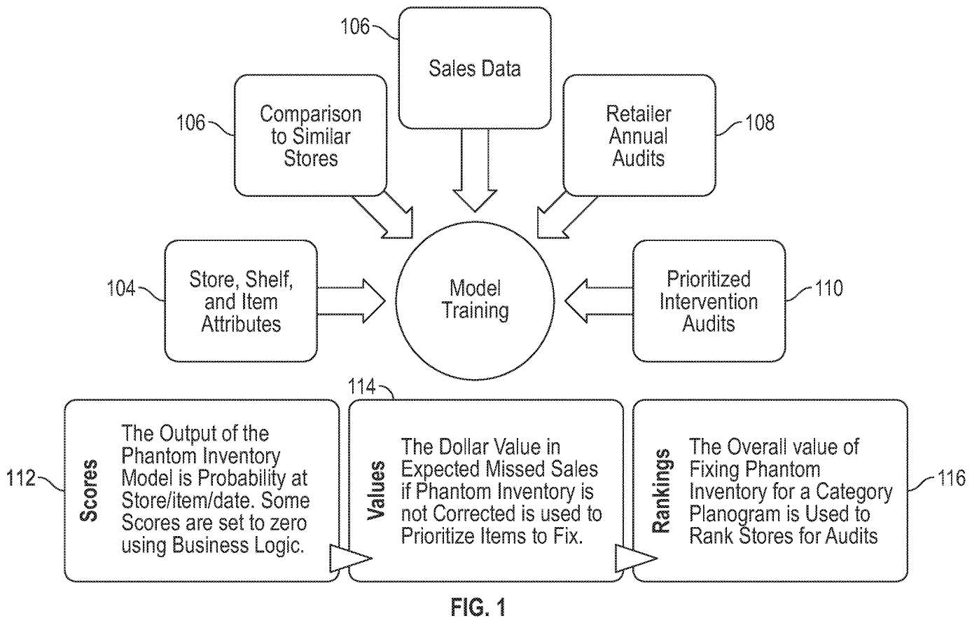

FIG. 1 illustrates an embodiment of the identification operation. The classification model may receive input information for model training 102, wherein the input information may comprise data such as store, shelf and item attributes data 104, comparison data to similar stores 106, sales data 107, retail annual audits data 108, prioritized intervention audits 110, and/or any other suitable type(s) of data. In some embodiments, retail annual audits data 108 may refer to any suitable amount of time instead of annual, such as daily, weekly, monthly, and the like. In embodiments, the correction operation of the classification model may comprise a payoff matrix to translate item-level probabilities and other data into a dollar value data. In some embodiments, this may include by way of non-limiting examples historical sales volume and dollar amounts, seasonality, inventory availability, and/or substitution estimates. As described further herein, the payoff matrix inputs to translate the item-level probabilities received from the identification operation to the dollar value may optionally comprise sales data (e.g., mean dollars in sales expected from that item at that store on that day), business data (e.g., hourly wage it would cost to intervene), expected store foot traffic data, consumer substitution behavior data, basket data, loyalty loss terms data, and the like. The payoff matrix inputs may capture a holistic impact of the phantom inventory. Based on the payoff matrix or other rankings, a targeted intervention may be utilized for high-value stores, item categories, or items. The high-value stores and item categories may be audited and the retailer inventory system may be corrected where necessary. This correction data can then be fed back to the classification model for retraining and improving the classification model. The automated re-ordering algorithm may be triggered to re-supply the store after correcting the retailer inventory.

FIG. 1 further illustrates the correction operation. The phantom inventory probability score may be calculated at the store, item and day level, and some phantom inventory probability scores may be set to zero using business logic 112. The dollar value in expected missing sales, if the case of phantom inventory is not corrected, may be used to prioritize the items that need intervention to fix phantom inventory 114. The overall value of fixing the phantom inventory for a category may be used to rank the stores for audits 116.

If available, the model input data to train the classification model to identify phantom inventory may be provided by a primary store audit of physical inventory, conducted by the retailer or by another party. The primary store audit may then be utilized to provide a ground truth to train the classification model. The classification model can train on a primary model data set from the primary store audit up until a date prior to a subsequent annual store audit. Each record in the training data may be assigned a target class label, in this example either 0 or 1. In this non-limiting example, 1 is a phantom inventory state and applies if: (1) the reported item inventory is greater than 0 on the day prior to the subsequent store audit; (2) adjusted (corrected) inventory is 0 at the end of the day of the subsequent audit; (3) and 0 units of the item are sold on the day of the subsequent audit. The requirement of 0 units of the item sold on the day of the audit is utilized such that the 0 item inventory at the end of the subsequent audit day is not related to selling out during the day. Otherwise, the record in the training data may be assigned a target class label of 0. An example is provided in Tables 1 and 2. In Table 1, the inventory is corrected by the audit from 19 to 12 units, and that item at that store was not in a phantom inventory state. In Table 2, the inventory has been corrected by the audit from 13 to 0 units, and that item in that store was in a phantom inventory state.

TABLE 1
An example an item not in a Phantom Inventory state on 2022
Aug. 3, regarding phantom inventory for the next day = 0.

| date ▴ | store_number ▴ | item_number ▴ | pos_units ▴ | inventory_start_units ▴ | inventory_end_units ▴ |
|---|---|---|---|---|---|
| 2022 Aug. 1 | [symbol] | 135 | 0 | 19 | [symbol] |
| 2022 Aug. 2 | 37 | 135 | 0 | 19 | 19 |
| 2022 Aug. 3 | 37 | 135 | 0 | 19 | 19 |
| 2022 Aug. 4 | 37 | 135 | 0 | 19 | 12 |
| 2022 Aug. 5 | 37 | 135 | 0 | 12 | 12 |

[symbol]

indicates data missing or illegible when filed

TABLE 2
An example of an item in a Phantom Inventory state on 2022
Aug. 3, regarding phantom inventory for the next day = 1.

| date ▴ | store_number ▴ | item_number ▴ | pos_units ▴ | inventory_start_units ▴ | inventory_end_units ▴ |
|---|---|---|---|---|---|
| 2022 Aug. 1 | 37 | 220 | 0 | [symbol] | 13 |
| 2022 Aug. 2 | 37 | 220 | 0 | [symbol] | 13 |
| 2022 Aug. 3 | 37 | 220 | 0 | 13 | 13 |
| 2022 Aug. 4 | 37 | 220 | 0 | [symbol] | 0 |
| 2022 Aug. 5 | 37 | 220 | 0 | 0 | 0 |

[symbol]

indicates data missing or illegible when filed

An exemplary embodiment of the classification model may use a Light Gradient Boosting Machine (LGBM) model based binary classification algorithm. Comparative tests conducted on the different binary classification algorithms-using tools such as AutoML in Databricks, which runs dozens of differently tuned models and ranks them based on selected metrics on either validation or test data-showed the LGBM model to have better performance. Nevertheless, other embodiments may utilize sklearn (a python based open-source Machine Learning package), binary classification algorithms including Logistic Regression, Random Forest, XGBOOST, and/or any other suitable algorithm(s).

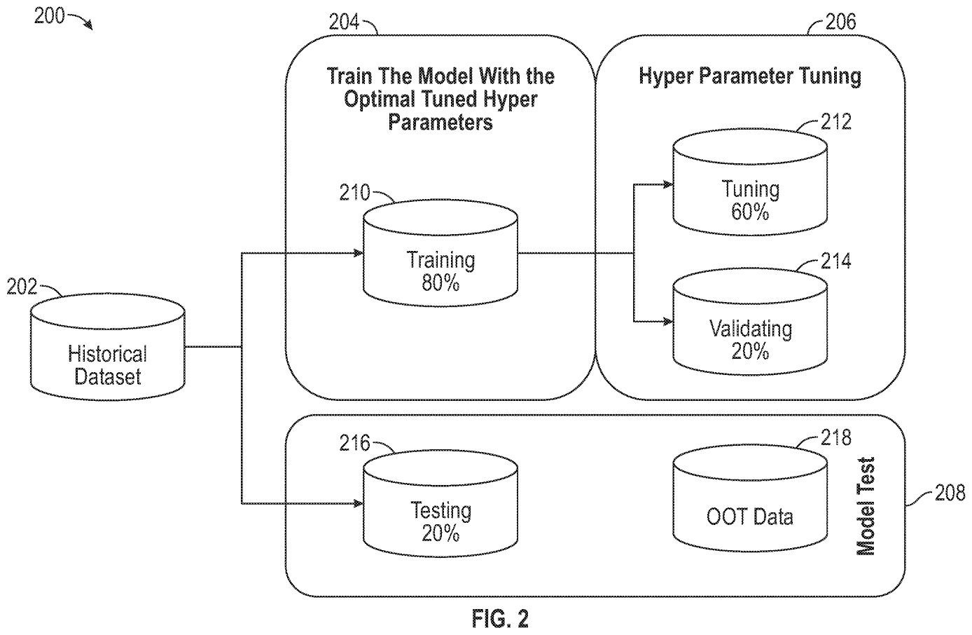

Turning to FIG. 2, the classification model may be trained on available historical dataset(s) 202, wherein the historical data set may be based on the audit data and the classification model inputs. The classification model may be trained with optimally-tuned hyperparameters 204. The hyperparameters (such as the learning rate of the algorithm, by way of non-limiting example) may be external to the classification model input and may be used to control the learning process of the classification model. In some embodiments, hyperparameter tuning 206 may be performed using a python based hyperopt package on a training subset (such as a tuning data subset 212) of 80% of the historical dataset. The hyperopt package in this embodiment is based on a Bayesian optimization. The training subset (such as a tuning data subset 212) of the historical dataset may be further split into a 60% tuning data subset 212 and a 20% validation data subset 214. The 60% tuning data subset 212 may be used to train the classification model to identify the phantom inventory. The 20% validation data subset 214 may be used to test the classification model trained on the 60% tuning data subset 212. As part of model testing 208, the tuned classification model may then be assessed on a 20% holdout test data subset 216, in which the holdout test data subset 216 may be the historical dataset 202 not used for tuning or validation of the classification model. An Out-of-time (OOT) testing may also be performed using an OOT dataset 218 from a period never seen by the classification model. This may be performed to achieve similar model performance on the test OOT dataset 218 as on the holdout test data subset 216. The impact of each input feature on the phantom inventory probability may be calculated using a python based Shapley Additive explanations (SHAP) interpretability package or similar feature importance calculation methods. SHAP is based on game theory concepts, and Shapley values may be used to estimate the contribution of a given feature to the phantom probability predictions of the classification model.

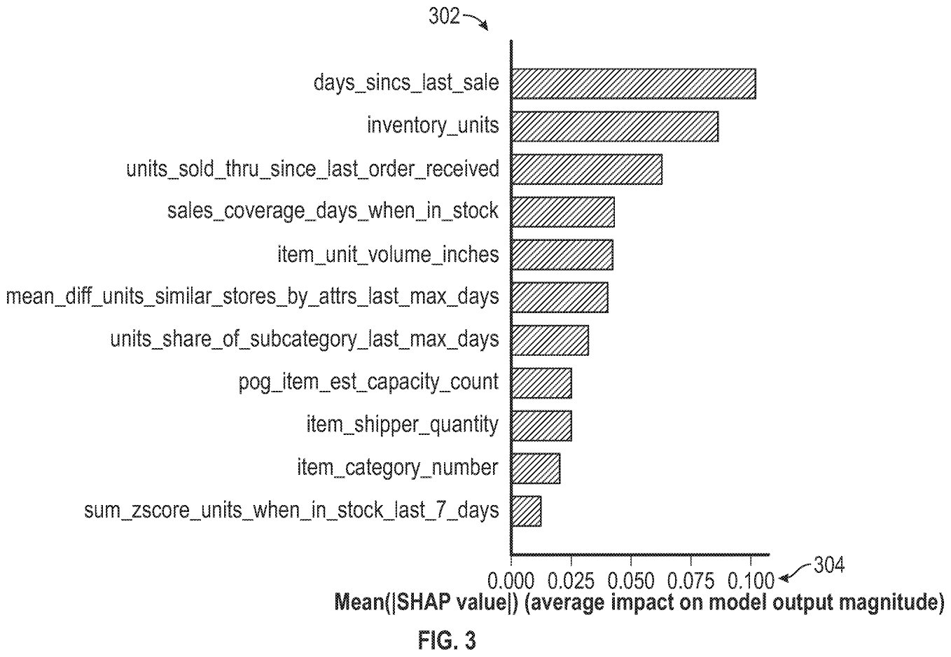

Turning to FIG. 3, a graphical illustration depicts the impact of different input features in embodiments. The y axis 302 may be used to represent the different input features and the x axis 304 with respect to the impact of each of the different input features on the phantom inventory probability by means of a mean SHAP value. From the graph, it can be seen that days since last sale and inventory units are the most important features that contribute to the phantom probability predictions of the classification model. Feature dependencies, which may be used to illustrate the influence of individual input features on predictions made by the classification model, may also be calculated with the SHAP interpretability package or similar feature importance calculation methods.

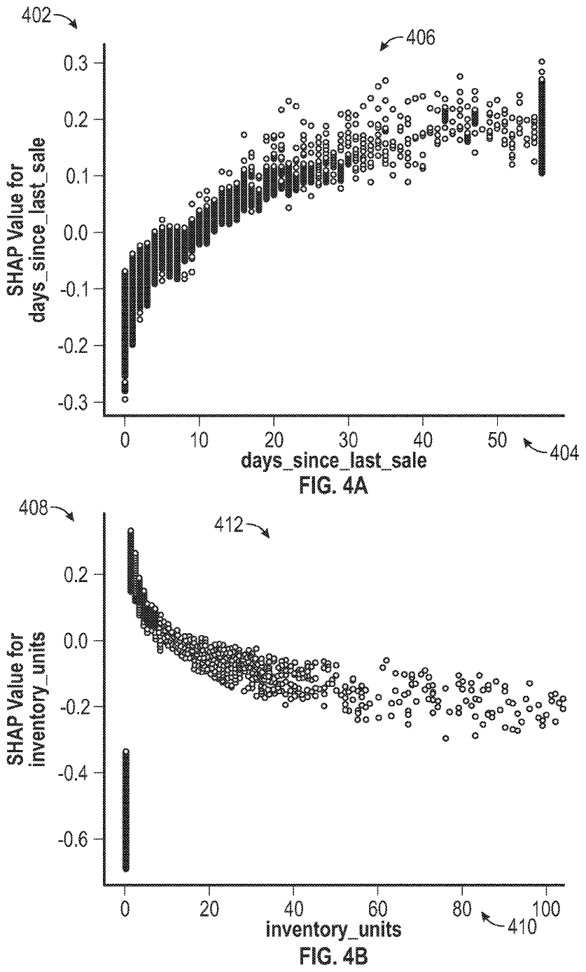

FIGS. 4A and 4B are exemplary graphical illustrations of the feature dependencies in terms of SHAP values on the y axes 402, 408 for the two most important features from FIG. 3, (i.e., days since last sale and inventory units), denoted on the x axes 404, 410. The inventory units=0 408 means target score=0 (if the system knows the inventory is zero, it is not “phantom”). The lower number of reported inventory units (e.g., reported inventory units 412), the more likely the target score=1. The greater the number of days since the last sale (e.g., days 406), the more likely the target score=1.

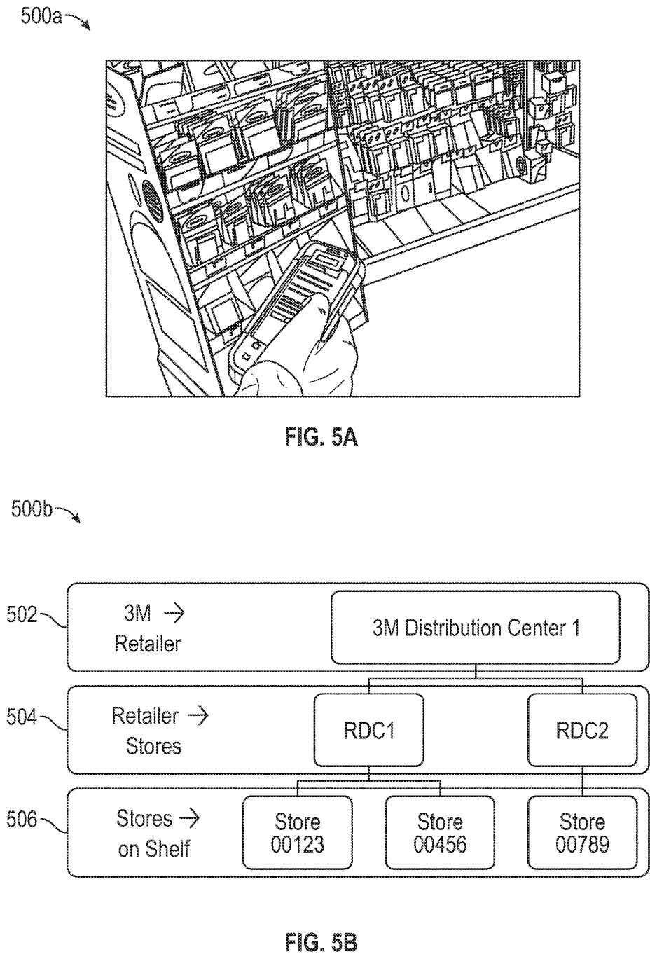

FIG. 5A illustrates an example of in-store audit 500a to count products on the shelf and correct any cases of phantom inventory in the store system. Embodiments may be flexible as to how the intervention is carried out. For example, a store associate could check all items within a category, where that category has been flagged as valuable to correct in that store on that day. This may take additional time, versus a spot check of specific items only, but could turn up items not flagged by the model that are in a state of phantom inventory and can then be corrected. A hybrid approach between a spot check and a full category check may involve the associate spot-checking flagged items and then additionally checking any “holes” in the POG or shelf to see if those items are truly out of stock or are phantom inventory. FIG. 5B shows the hierarchy of product flow from the manufacturer to rapid deployment centers to individual stores. In FIG. 5B, different categories of intervention may include a distribution center level 502, rapid deployment centers (RDCs) level 504 that receive products from the manufacturer (such as 3M®), and store-level allocating 506 based on estimated current need. The estimated value of intervening could be consumed by the RDCs, for example via an application programming interface (API), and this could trigger micro re-allocations. This may allow the business to impose its own logic and/or benefit calculations on top of the method output. In some embodiments, the intervention could be algorithmic at the RDCs. A variety of metrics may be considered for evaluating the classification model performance, including:
Accuracy: percentage of cases where the classification model phantom inventory probability predictions matches actual phantom inventory. Interpretation may depend on a relative ratio of actual phantom inventory (PI) cases vs not-PI cases (e.g., 8% actual PI, a model predicting always not-PI is 92% “accurate”).
Area Under Curve (AUC): area under a curve for a Receiver Operating Characteristic (ROC) plot of true positive rate vs false positive rate which provides a measure of the degree to which the classification model separates classes, independent of the classification threshold.
Kolmogorov-Smirnov Test (KS): statistic that compares the model probability distributions of the actual PI vs actual not-PI cases. A high KS value means the classification model does a good job separating the classes, again independent of threshold.
d-prime: a sensitivity index, from signal detection theory, which is a measure of the separation between the model probability distributions of the actual PI vs actual not-PI cases, taking their scatter into account.
beta: an optimal threshold, from signal detection theory, considering cost/benefit of correct rejection, false alarm, misses, and hits: the payoff matrix. For PI this can be at an item level with the business providing a payoff matrix.

Classification Models with a higher d-prime value may be preferred in some embodiments, as the higher d-prime value may correspond to a cleaner separation of the predicted probability distribution of the two classes. Because the problem is imbalanced (there are many more cases of PI=0 than there are of PI=1), some metrics result in good identification of PI=0 cases. From a business perspective, however, a good identification of PI=1 cases is equally or more important. Embodiments of the model may be tuned using d-prime as the optimization metric and evaluated using the d-prime OOT score. In this example, optimizing based on d-prime resulted in better class separation than some alternative optimization metrics.

For the correcting operation, some embodiments may use the payoff matrix to estimate the net benefit of correcting a classification model-identified case of potential phantom inventory. The estimated value of intervening may be calculated based on the average duration in days until phantom inventory would be corrected under business-as-usual conditions (e.g., until an automated re-order, or until an internal store audit), minus the time it takes to restock after correction of the inventory system, multiplied by the average dollar value in daily sales that would have been expected for that item at that store were it actually in stock. The cost in wages and lost opportunity for an associate to go check that item may be subtracted. The item-level estimated values of intervening can be aggregated up to the sub-category, or category (e.g., across all painter tape), or the store, by way of non-limiting example.

One non-limiting example of determining the estimated value of intervening is: Estimated value of intervening=((average days until phantom inventory would be corrected−time to restock)×(expected average dollar value in daily sales of item if in stock))−cost in wages and opportunities, although any suitable way may be utilized. The payoff matrix estimates may then be used to rank the stores to prioritize the inventory audits.

Some modifications to the payoff matrix approach may provide improved efficiency. By way of non-limiting example, instead of simple average daily sales, it could be average sales by day of the week. Under that approach, products that sell a lot on weekends might be made to bubble up for intervention more frequently on Fridays than a higher payoff item that is not likely to sell on Monday.

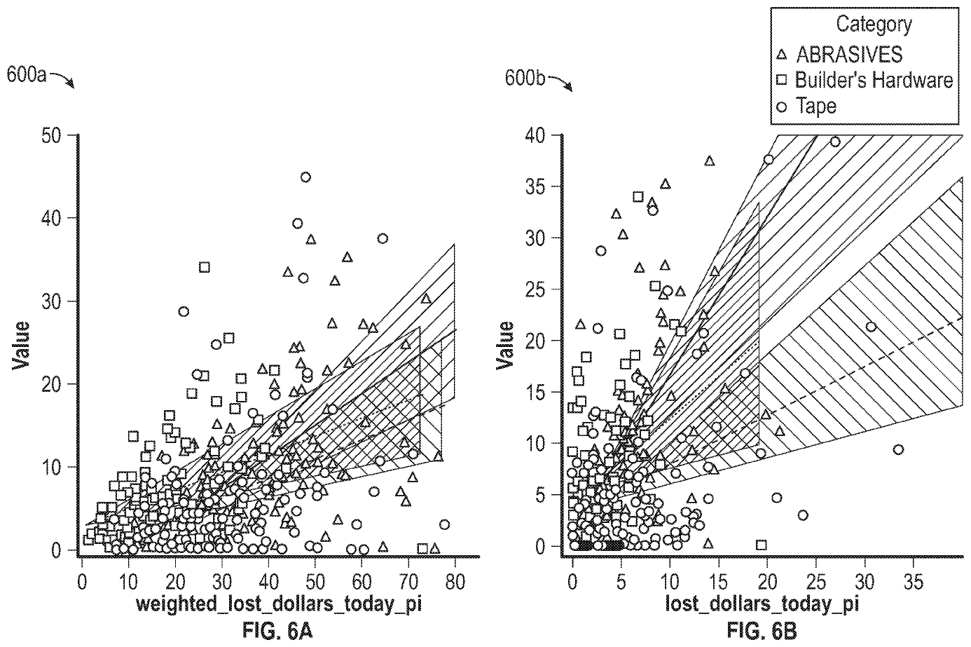

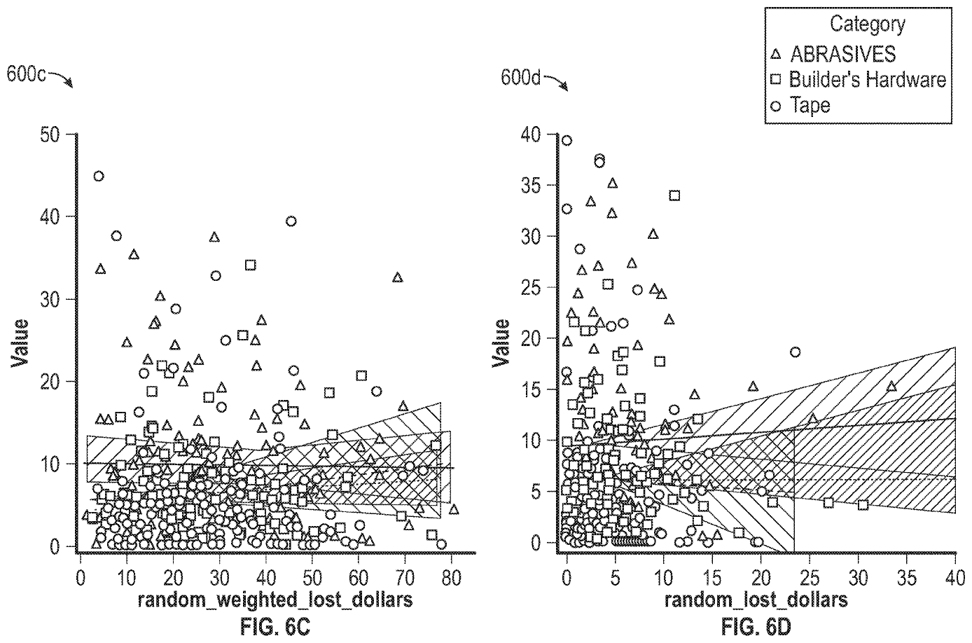

Here, the results of an illustrative payoff matrix calculation are shown as being based on POS mean daily sales as well as typical times until phantom inventory is resolved absent intervention. This exemplary scenario is based on in-store audits to correct phantom inventory. FIGS. 6A-D illustrate the positive correlation between predicted and inferred actual value 600a (weighted), 600b (unweighted) in contrast to a random shuffling benchmark 600c (weighted), 600 (unweighted). Values are based on a day prior to the subsequent store audit to provide primary data set. The predicted payoff values show a sufficient positive correlation to the inferred actual payoff values (600a, 600b) for all three key categories considered, in contrast to a random shuffling (600c, 600d) where no correlations are present. Therefore, this confirms that the methods herein work to prioritize stores and categories at which to intervene.

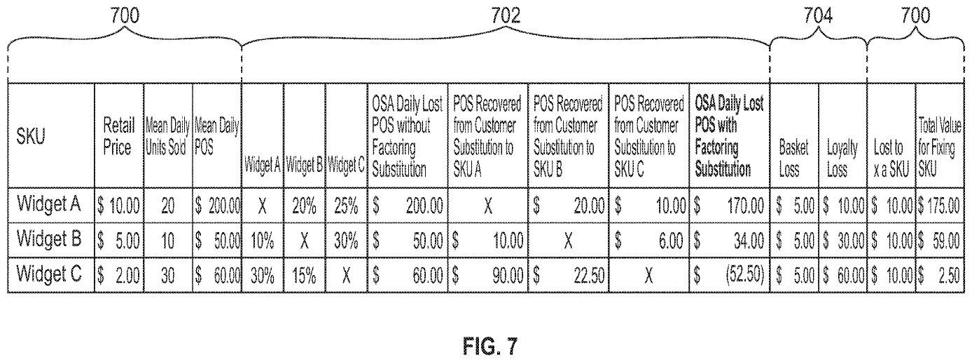

Turning to FIG. 7, a matrix is depicted to demonstrate further data to show that more complex payoff matrix calculations are possible. Starting with POS mean values 700, then considering customer substitution behavior 702, and finally adding basket and loyalty loss estimates 704. Thus, some embodiments may identify phantom inventory through a classification model, then correct it through in-store audits prioritized based on payoff value.

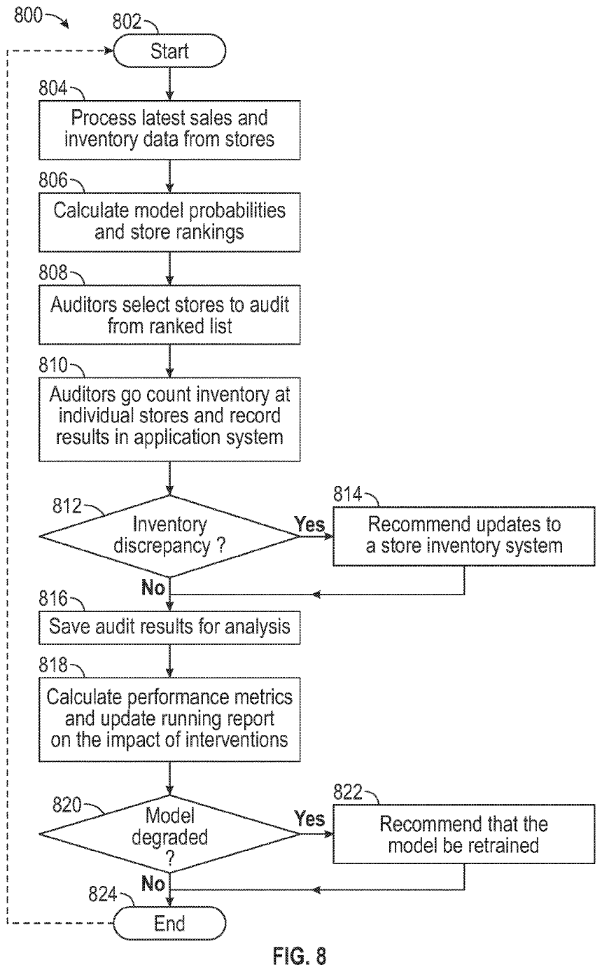

Turning to FIG. 8, an exemplary flowchart 800 for identifying/correcting phantom inventory, which can run daily or at any other suitable frequency. At block 802, the flowchart begins and may proceed to block 804 to process the latest sales data and inventory data from the stores. At block 806, input data to the classification model may be received to predict phantom inventory probabilities for individual items. Phantom inventory probabilities may be utilized in the payoff matrix estimate calculation to determine a ranked list of recommended stores for auditing. A recommended ranked list of stores may also be displayed to a user, such as an auditor.

At block 808, the user can then select the specific stores that they wish to prioritize for audits. At block 810, auditors can then go to the specific stores and perform an inventory audit. Details of the audit process are described herein. Information collected during the store audit by the auditor may be input into the system to save the data. At block 812, a comparison of the information from the store audit to the last known inventory record to reveal an inventory discrepancy may be performed. If there is a discrepancy (condition YES), then at block 814 updates may be recommended to the store's inventory system, and the flowchart proceeds to block 816. Otherwise, if there is no inventory discrepancy (condition NO), then the flowchart proceeds directly to block 816 to save the final results of the audit for additional analysis.

At block 818, performance metrics/key performance indicators (KPIs) may be calculated to measure the classification model performance and the impact of auditor intervention to correct the inventory system. At block 820, the classification model may be monitored via the performance metrics and/or KPIs for model degradation. If the model has degraded (condition YES), then at block 822 a recommendation for retraining of the classification model based on the monitoring results may be provided, and the flowchart may terminate at block 824. Otherwise if the model has not degraded (condition NO), then the flowchart may proceed directly to terminate at block 824. In some embodiments, at block 824 the flowchart may loop and return back to block 802 for further execution.

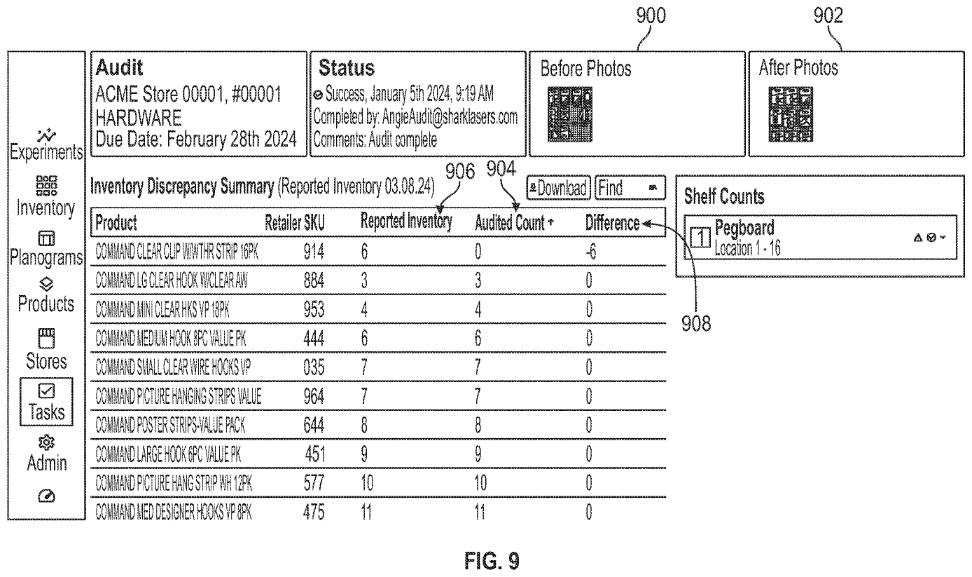

The classification model can be run on a software application. The software application can, by way of non-limiting example, provide the auditors with store rankings and store their audit result data. Other methods of passing and recording information can also be used, such as API calls. FIG. 9 illustrates an example of a front-end user interface of the software application described here. The auditor can take one or more before photos 900 of the shelves comprising the items in the store. The photos may show the items out of stock, some of which may constitute phantom inventory, as well as other deficiencies, such as mis-shelved of items, that may also be corrected by the auditor. The auditor may then count how many of each item are present, and the location(s) of each of the items within the store. The auditor may also collect additional metadata including but not limited to one or more after photos 902 to document the completion of the audit.

After completing the audit, the software application may produce a summary of the results. By way of non-limiting example, the count found by the auditor may be labeled as the Audited Count column 904 in the table titled Inventory Discrepancy Summary. In many cases, the audited count matches the store inventory system record, which is the Reported Inventory column 906, such that the difference, denoted by the Difference column 908, may be zero units. In other cases, there may be a non-zero difference, and the audit may help the store to correct inventory. Specifically, when the reported inventory is greater than zero and the audited count is zero (and no items are sold that day), the item can be corrected from a state of phantom inventory. The first row depicts an example of phantom inventory, in which the reported inventory is corrected from six units to zero. The corrected inventory will then enable replenishment for the zero inventory and also optionally for low inventory or following other retailer logic. The replenishment (e.g., from a deployment center) may occur after completing the audit. In some embodiments, instructions can be provided to (i) a user to replenish inventory for unavailable items and/or (ii) automatically replenish inventory for unavailable items. After the out-of-stock items are replenished, it is expected they will resume being purchased by consumers at that store, providing a positive outcome to the consumer, the retailer, and the manufacturer alike.

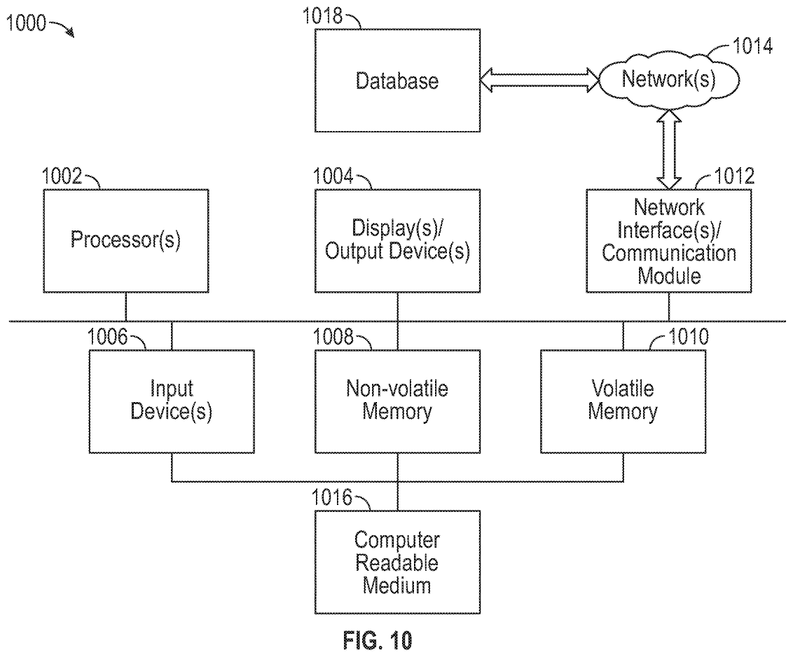

Referring now to FIG. 10, a block diagram illustrates computing hardware, such as an exemplary computing device 1000, through which embodiments of the disclosure can be implemented. The computing device 1000 described herein is but one example of a suitable computing device and does not suggest any limitation on the scope of any embodiments presented. Nothing illustrated or described with respect to the computing device 1000 should be interpreted as being required or as creating any type of dependency with respect to any element or plurality of elements. In various embodiments, the computing device 1000 may include, but need not be limited to, a desktop, laptop, server, client, tablet, smartphone, computing cloud or any other type of device that can utilize data. In an embodiment, the computing device 1000 includes at least one processor 1002 and memory comprising non-volatile memory 1008 and/or volatile memory 1010. The computing device 1000 can include one or more displays, display hardware, and/or output devices 1004 such as, for example, AR/VR/MR/XR hardware, monitors, speakers, headphones, projectors, wearable-displays, holographic displays, and/or printers. Output devices 1004 may further include, for example, displays and/or speakers, devices that emit energy (radio, microwave, infrared, visible light, ultraviolet, x-ray and gamma ray), electronic output devices (Wi-Fi, radar, laser, etc.), audio (of any frequency), and the like.

The computing device 1000 may further include one or more input devices 1006 which can include, by way of example, any type of mouse, keyboard, disk/media drive, memory stick/thumb-drive, memory card, pen, touch-input device, biometric scanner, gaze and/or blink tracker, tracker, voice/auditory input device, motion-detector, camera, scale, and any device capable of measuring data such as motion data (e.g., an accelerometer, GPS, a magnetometer, a gyroscope, etc.), biometric data (e.g., blood pressure, pulse, heart rate, perspiration, temperature, voice, facial-recognition, motion/gesture tracking, gaze tracking, iris or other types of eye recognition, hand geometry, oxygen saturation, glucose level, fingerprint, DNA, dental records, weight, or any other suitable type of biometric data, etc.), video/still images, and audio (including human-audible and human-inaudible ultrasonic sound waves). Input devices 1006 may include any type of device capable of receiving data, whether from another device, visual and/or audio data captured from the real world, object detection data, and the like. Input devices 1006 may include cameras (with or without audio recording), such as digital and/or analog cameras, still cameras, video cameras, thermal imaging cameras, infrared cameras, cameras with a charge-couple display, night-vision cameras, three-dimensional cameras, webcams, audio recorders, and the like.

The computing device 1000 typically includes non-volatile memory 1008 (e.g., ROM, flash memory, etc.), volatile memory 1010 (e.g., RAM, etc.), or a combination thereof. A network interface 1012 can facilitate communications over a network 1014 with other data source such as a database 1018 via wires, a wide area network, a local area network, a personal area network, a cellular network, a satellite network, and the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks may include, but are not limited to, technologies such as LTE, WiMAX, UMTS, CDMA, and GSM. Network interface 1012 can be communicatively coupled to any device capable of transmitting and/or receiving data via one or more network(s) 1014. Accordingly, the network interface 1012 can include a communication transceiver for sending and/or receiving any wired or wireless communication. For example, the network interface 1012 may include an antenna, a modem, LAN port, Wi-Fi card, WiMax card, mobile communications hardware, near-field communication hardware, satellite communication hardware and/or any wired or wireless hardware for communicating with other networks and/or devices.

A computer-readable medium 1016 comprises one or more plurality of computer readable mediums, each of which is non-transitory. A computer readable medium may reside, for example, within an input device 1006, non-volatile memory 1008, volatile memory 1010, or any combination thereof. A readable storage medium can include tangible media that is able to store instructions associated with, or used by, a device or system. A computer readable medium, also referred to herein as a non-transitory computer readable medium, includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A non-transitory computer readable medium may also include, for example, a system or device that is of a magnetic, optical, semiconductor, or electronic type. A non-transitory computer readable medium excludes carrier waves and/or propagated signals taking any number of forms such as optical, electromagnetic, or combinations thereof.

The computing device 1000 may include one or more network interfaces 1012 to facilitate communication with one or more remote devices, which may include, for example, client and/or server devices. The network interface 1012 may also be described as a communications module, as these terms may be used interchangeably. The database 1018 is depicted as being accessible over the network 1014 and may reside within a server, the cloud, or any other configuration to support being able to remotely access data and store data in the database 1018.

What is claimed is:

1. A method comprising:
calculating model probabilities and a ranked list of locations;
receiving a selection of a plurality of the ranked locations;
receiving actual item count data from at least a subset of the selected locations;
comparing the actual item count data to a corresponding inventory record; and
outputting a discrepancy indication based upon a discrepancy between the actual item count data and the corresponding inventory record.

2. The method of claim 1, further comprising outputting instructions to replenish inventory for unavailable items or as indicated by a model as being likely unavailable.

3. The method of claim 1, wherein the ranking of locations is based at least in part on an overall value of fixing the discrepancy within a category.

4. The method of claim 1, further comprising monitoring the classification model performance with calculated performance metrics based at least in part on received input comprising auditor intervention to correct inventory quantity.

5. The method of claim 4, wherein the monitoring further comprises utilizing performance metrics for model degradation.

6. The method of claim 5, further comprising retraining the model based upon detected model degradation.

7. The method of claim 1, wherein the model probability comprises a probability of an item not being present at a location on a particular date.

8. At least one non-transitory computer-readable medium storing instructions that, when executed, configure at least one processor for:
calculating model probabilities and a ranked list of locations;
receiving a selection of a plurality of the ranked locations;
receiving actual item count data from at least a subset of the selected locations;
comparing the actual item count data to a corresponding inventory record; and
outputting a discrepancy indication based upon a discrepancy between the actual item count data and the corresponding inventory record.

9. The at least one non-transitory computer-readable medium of claim 8, wherein the ranked locations are determined at least in part by a payoff matrix estimate calculation.

10. The at least one non-transitory computer-readable medium of claim 8 wherein the at least one processor is further configured for outputting instructions to replenish inventory for unavailable items or as indicated by a model as being likely unavailable.

11. The at least one non-transitory computer-readable medium of claim 8 wherein the ranking of locations is based at least in part on an overall value of fixing the discrepancy within a category.

12. The at least one non-transitory computer-readable medium of claim 8 wherein the at least one processor is further configured for monitoring the classification model performance with calculated performance metrics based at least in part on received input comprising auditor intervention to correct inventory quantity.

13. The at least one non-transitory computer-readable medium of claim 12, wherein the monitoring further comprises utilizing performance metrics for model degradation.

14. The at least one non-transitory computer-readable medium of claim 13 wherein the at least one processor is further configured for retraining the model based upon detected model degradation.

15. The at least one non-transitory computer-readable medium of claim 8, wherein the model probability comprises a probability of an item not being present at a location on a particular date.

16. A system comprising:
at least one computing device comprising one or more processors; and
at least one memory coupled to at least one of the one or more processors, wherein the at least one memory comprises instructions that configure the at least one computing device to:
calculate model probabilities and a ranked list of locations;
receive a selection of a plurality of the ranked locations;
receive actual item count data from at least a subset of the selected locations;
compare the actual item count data to a corresponding inventory record; and
output a discrepancy indication based upon a discrepancy between the actual item count data and the corresponding inventory record.

17. The system of claim 16, wherein the at least one computing device is further configured to output instructions to replenish inventory for unavailable items or as indicated by a model as being likely unavailable.

18. The system of claim 16, wherein the ranking of locations is based at least in part on an overall value of fixing the discrepancy within a category.

19. The system of claim 16, wherein the at least one computing device is further configured to monitor the classification model performance with calculated performance metrics based at least in part on received input comprising auditor intervention to correct inventory quantity.

20. The system of claim 19, wherein the monitoring further comprises utilizing performance metrics for model degradation.
